(19) United States
(12) Patent Application Publication
(10) Pub. No.: US 2024/0245125 A1
(43) Pub. Date: Jul. 25, 2024

(54) AEROSOL GENERATOR

(71) Applicant: SHENZHEN FIRST UNION TECHNOLOGY CO., LTD., Shenzhen, Guangdong Province (CN)

(72) Inventors: Weifeng GONG, Shenzhen, Guangdong Province (CN); Zhongli XU, Shenzhen, Guangdong Province (CN); Yonghai LI, Shenzhen, Guangdong Province (CN)

(73) Assignee: SHENZHEN FIRST UNION TECHNOLOGY CO., LTD., Shenzhen, Guangdong Province (CN)

(21) Appl. No.: 18/693,979

(22) PCT Filed: Sep. 27, 2022
(86) PCT No.: PCT/CN2022/121822

§ 371 Date: Mar. 21, 2024

(30) Foreign Application Priority Data
Sep. 28, 2021 (CN) 202111141863.7

(51) Int. Cl. A24F 40/46; A24F 40/10; A24F 40/20; A24F 40/30; H05B 3/06

(52) U.S. Cl. CPC A24F 40/46; A24F 40/10; A24F 40/20; A24F 40/30; H05B 3/06; H05B 2203/016

(57) ABSTRACT

An aerosol generator includes a first vaporizer, a circuit board, and a connecting assembly. The connecting assembly includes a conductive connector electrically connecting a first electrode to a second electrode. The first electrode is separably connected to the second electrode by means of the connector. The first electrode and the second electrode are located on a same side of the connector. Since the first vaporizer and the circuit board are located on a same side with respect to the connecting assembly, the first electrode is indirectly electrically connected to the second electrode by means of the connector, and at least one of the first electrode and the second electrode is separable from the connector. When the first vaporizer needs to be removed, the first electrode is electrically disconnected from the second electrode, or when the first vaporizer is loaded, the first electrode may be electrically connected to the second electrode.

### CROSS-REFERENCE TO RELATED APPLICATIONS

This application claims priority to Chinese Patent Application No. 202111141863.7, filed with the China National Intellectual Property Administration on Sep. 28, 2021 and entitled “AEROSOL GENERATOR”, which is incorporated herein by reference in its entirety.

### TECHNICAL FIELD

Embodiments of this application relate to the field of aerosol generation technologies, and in particular, to an aerosol generator.

### BACKGROUND

An existing aerosol generator usually includes a shell. A vaporizer and a power supply assembly are arranged inside the shell. The vaporizer may generate an aerosol during operation. The aerosol may enter a mouthpiece, and the power supply assembly supplies power to the vaporizer. In a current disposable aerosol generator, the vaporizer is usually electrically connected to the power supply assembly through lead welding. In a case of a removable vaporizer, an existing vaporizer is usually located on an upper end of a circuit board and the power supply assembly, an electrode of the vaporizer is arranged downward, and an electrode of the circuit board connected to the power supply assembly is arranged upward. When the vaporizer enters the shell from an upper end of the shell, the electrode at the bottom of the vaporizer is in direct contact with the electrode of the circuit board. To be specific, the vaporizer may be electrically connected to the power supply assembly, and the structure is simple. When the vaporizer and the circuit board are required to be arranged in parallel, how to electrically connect the vaporizer to the circuit board without the circuit board affecting mounting and removal of the vaporizer is an urgent problem to be resolved.

### SUMMARY

In an aerosol generator provided in embodiments of this application, a first vaporizer may be indirectly electrically connected to a circuit board by means of a connecting assembly without affecting mounting and removal of the first vaporizer.

An aerosol generator provided in an embodiment of this application includes:
a first vaporizer, configured to vaporize a first vaporizable substrate to generate an aerosol, where the first vaporizer includes a first electrode;
a power supply assembly, configured to provide electric energy required by the first vaporizer to generate the aerosol;
a circuit board, connected to the power supply assembly, where the circuit board includes a second electrode for conveying the electric energy; and
a connecting assembly, including a conductive connector, where
the first vaporizer and the circuit board are located on a same side of the connecting assembly; and
the connector is configured to electrically connect the first electrode to the second electrode, and at least one of the first electrode and the second electrode is separably connected to the connector.

An embodiment of this application provides another aerosol generator, including: a housing, where the housing is internally provided with a first vaporizer and a power supply assembly; and
a connection cover movably connected to the housing, where
the first vaporizer includes a first electrode, and the housing is further internally provided with a second electrode electrically connected to the power supply assembly;
the housing is provided with an assembly opening, and the first vaporizer is accommodated into the housing through the assembly opening or removed from the housing through the assembly opening; and
the connection cover is configured to cover the assembly opening in a first state, keep the first vaporizer in the housing, and open the assembly opening in a second state, where the connection cover is able to connect the first electrode to the second electrode in the first state.

An aerosol generator provided in an embodiment of this application includes:
a first vaporizer, configured to generate an aerosol, where the first vaporizer includes a first electrode;
a power supply assembly, configured to provide electric energy required by the first vaporizer to generate the aerosol;
a circuit board, connected to the power supply assembly, where the circuit board includes a second electrode for conveying the electric energy; and
a connecting assembly, including a conductive connector, where
the connector is elongated, one end of the connector is configured to electrically connect the first electrode, an other end thereof is configured to electrically connect the second electrode, and at least one of the first electrode and the second electrode is separably connected to the connector.

Still another aerosol generator provided in an embodiment of this application includes a housing, where the housing is provided with an air outlet and an assembly opening, and the assembly opening and the air outlet are arranged at two opposite ends of the housing; and the housing is internally provided with:
a first vaporizer, including a first electrode, where the first electrode extends in an axial direction of the assembly opening;
a circuit board, including a second electrode;
a power supply assembly; and
a conductive connector, arranged in a radial direction of the assembly opening, where
the circuit board is electrically connected to the power supply assembly; the first vaporizer is arranged on a side of the circuit board; the first vaporizer is enabled to enter or leave the housing in the axial direction of the assembly opening; and the connector abuts against the first electrode and is connected to the second electrode, so that the first vaporizer is electrically connected to the circuit board.

According to the foregoing aerosol generators, since the first vaporizer and the circuit board are located on the same side with respect to the connecting assembly, the first electrode of the first vaporizer is indirectly electrically connected to the second electrode on the circuit board by means of the connector on the connecting assembly, and at least one of the first electrode and the second electrode is separable from the connector, when the first vaporizer needs to be removed, the first electrode is electrically disconnected from the second electrode, or when the first vaporizer is loaded, the first electrode may be electrically connected to the second electrode, to provide the electric energy of the power supply assembly for operation of the first vaporizer. Through this design scheme through electrical connection, the circuit board may be indirectly connected to the first vaporizer without affecting the mounting and removal of the first vaporizer.

### BRIEF DESCRIPTION OF THE DRAWINGS

One or more embodiments are exemplarily described with reference to figures in accompanying drawings corresponding to the embodiments, and the exemplary descriptions do not constitute a limitation on the embodiments. Elements in the accompanying drawings that have same reference numerals are represented as similar elements, and unless otherwise particularly stated, the figures in the accompanying drawings are not drawn to scale.

FIG. 1 is a schematic diagram of a connecting assembly according to an embodiment of this application.

FIG. 2 is a schematic exploded view of an aerosol generator according to an embodiment of this application.

FIG. 3 is another schematic exploded view of an aerosol generator according to an embodiment of this application.

FIG. 4 is still another schematic exploded view of an aerosol generator according to an embodiment of this application.

FIG. 5 is a cross-sectional view of an aerosol generator according to an embodiment of this application.

FIG. 6 is a schematic diagram of a first vaporizer according to an embodiment of this application.

FIG. 7 is another schematic diagram of a first vaporizer according to an embodiment of this application.

FIG. 8 is a cross-sectional view of a first vaporizer according to an embodiment of this application.

FIG. 9 is a schematic diagram of a fixing seat according to an embodiment of this application.

FIG. 10 is a schematic diagram of a second vaporizer according to an embodiment of this application.

FIG. 11 is a schematic diagram of a connection terminal according to an embodiment of this application.

### IN THE FIGURES

1. Connecting assembly; 11. Connection cover; 12. Connector; 121. Positive connector; 122. Negative connector; 13. First air inlet; 14. Retaining structure; 15. Groove;
2. First vaporizer; 211. Liquid storage space; 22. E-liquid guide member; 23. First electrode; 24. Seal member; 241. Liquid passage; 242. Negative pressure hole; 243. Negative pressure plug; 25. Mounting seat; 251. Second air inlet; 252. Liquid absorbing member; 26. Liquid storage groove;
3. fixing seat; 31. Main body portion; 311. Assembly opening; 32. Extending portion; 321. Via; 322. Charging hole; 323. First portion; 324. Second portion; 325. Stepped surface;
4. Power supply assembly; 41. Battery fixing seat; 42. Battery; 43. Circuit board; 44. Second electrode; 441. Insulating portion; 442. Conductive portion;
5. Second vaporizer; 51. Heating element; 511. Arc-shaped sheet; 52. Wire; 53. Cigarette;
6. Housing;
7. Connecting seat; 71. Gas chamber; 72. Sealed cavity; 73. Through hole; 74. Airflow sensor;
8. Connection terminal; 9. Gas path.

### DETAILED DESCRIPTION

The technical solutions in embodiments of this application are clearly and completely described below with reference to the accompanying drawings in the embodiments of this application. Apparently, the described embodiments are merely some rather than all of the embodiments of this application. All other embodiments derived by a person of ordinary skill in the art based on the embodiments of this application without creative efforts shall fall within the protection scope of this application.

The terms “first”, “second”, and “third” in this application are merely intended for a purpose of description, and shall not be understood as an indication or implication of relative importance or implicit indication of the quantity or order of indicated technical features. All directional indications (for example, up, down, left, right, front, and back) in the embodiments of this application are only used for explaining relative position relationships, movement situations, or the like among the various components in a specific posture (as shown in the accompanying drawings). If the specific posture changes, the directional indication changes accordingly. In addition, the terms “include”, “have”, and any variant thereof are intended to cover a non-exclusive inclusion. For example, a process, a method, a system, a product, or a device that includes a series of steps or units is not limited to the listed steps or units, and instead, further optionally includes a step or unit that is not listed, or further optionally includes another step or unit that is intrinsic to the process, method, product, or device.

Embodiments mentioned in the specification mean that particular features, structures, or characteristics described with reference to the embodiments may be included in at least one embodiment of this application. The term appearing at different positions of this specification may not be the same embodiment or an independent or alternative embodiment that is mutually exclusive with other embodiments. A person skilled in the art explicitly or implicitly understands that the embodiments described in this specification may be combined with other embodiments.

It should be noted that, when an element is referred to as “being fixed to” another element, the element may be directly located on the another element, or an intermediate element may exist. When an element is considered to be “connected to” another element, the element may be directly connected to the another element, or one or more intermediate elements may simultaneously exist between the element and the another element. The terms “vertical”, “horizontal”, “left”, “right”, and similar expressions used in this specification are only for purposes of illustration, and do not represent a unique implementation.

An embodiment of this application provides a connecting assembly, including a conductive portion and an insulating portion. The connecting assembly is indirectly electrically conductive. The conductive portion is enabled to have a length, so that a first electric conductor (such as a vaporizer) and a second electric conductor (such as a circuit board) that are staggered from each other in space are respectively connected to the conductive portion, and the first electric conductor can be indirectly electrically connected to the second electric conductor. In particular, the electrical connection is realized between the first electric conductor and the second electric conductor that do not have direct contact conditions in space. The conductive portion of the connecting assembly is connected through contact to an electric conductor connected thereto, so the electrical connection may be easily removed, and the electrical connection may be easily enabled through contact. The connecting assembly is especially suitable for scenarios in two states in which the connected electric conductor needs to be electrically disconnected and electrically connected. A user may conveniently operate to change a position of the conductive portion through the insulating portion, so that contact and non-contact between the conductive portion and the electric conductor to which the conductive portion is connected is realized.

An embodiment of this application provides an aerosol generator, including a housing, a first vaporizer for generating an aerosol, a power supply assembly for providing electric energy for operation of a plurality of assemblies of the aerosol generator, a circuit board for carrying a variety of electronic components (including a power output interface), and a connecting assembly. The circuit board and the power supply assembly are located in the housing, while the connecting assembly may be located within the housing, outside the housing, or defined as a part of the housing. The first vaporizer may be arranged in the housing as a whole or partially based on a requirement of an overall shape.

The first vaporizer may be a vaporizer containing a liquid aerosol substrate, or may be a vaporizer containing a solid aerosol substrate, or may be a vaporizer for fixing and baking a cigarette and a similar substance. The first vaporizer is configured to operate and generate heat during electrical connection, so that the aerosol substrate inside the first vaporizer or the cigarette fixed by the first vaporizer generates an aerosol.

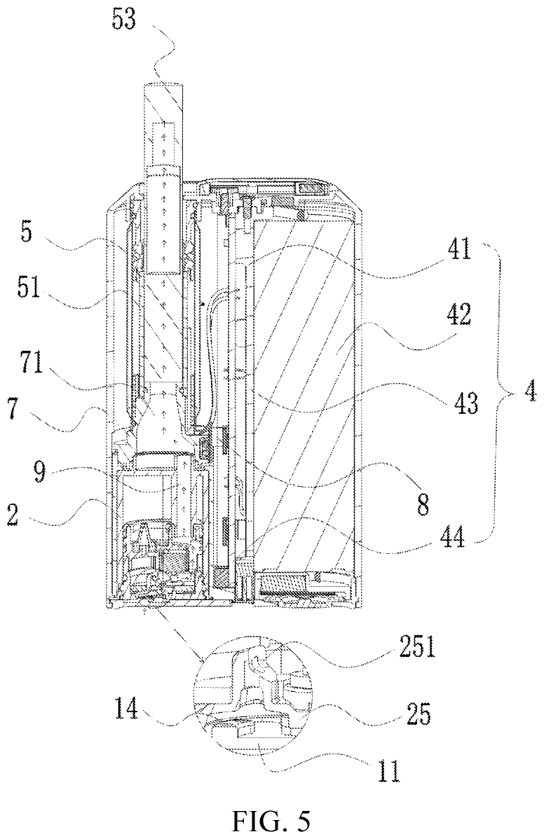

In some embodiments, referring to FIG. 5 to FIG. 8, a first vaporizer 2 is a vaporizer containing a liquid aerosol substrate. The first vaporizer 2 includes a liquid storage space 211 for storing a liquid aerosol substrate. The first vaporizer 2 includes an e-liquid guide member 22 and a heating body. The e-liquid guide member 22 may contact the liquid aerosol substrate in the liquid storage space 211, and transmit the liquid aerosol substrate to a heating range of the heating body through a capillary phenomenon, an osmotic phenomenon, or the like. The heating body may generate heat during electric conduction. The heat may vaporize the liquid aerosol substrate to form the aerosol. The first vaporizer 2 includes a gas path 9, which is configured to transmit the generated aerosol out of the first vaporizer 2. The first vaporizer 2 includes a first electrode 23, which is configured to be electrically connected to the heating body to supply power to the heating body for generating heat.

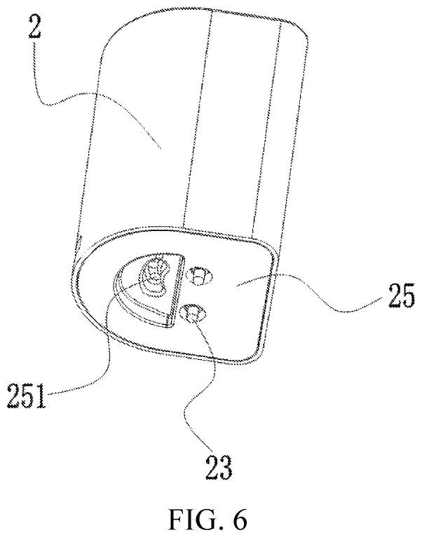

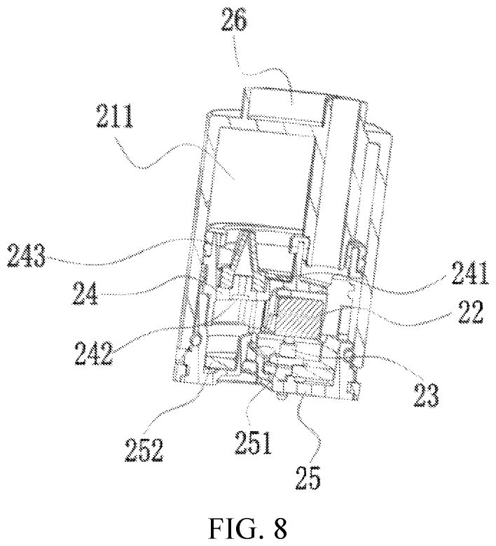

In the embodiments shown in FIG. 6 and FIG. 8, the e-liquid guide member 22 is a ceramic core, and the heating body includes a sheet body printed on the ceramic core and a positive electrode and a negative electrode located on two ends of the sheet body. The foregoing first electrode 23 includes two electrode terminals independent of each other, which are respectively a positive electrode and a negative electrode of the heating body. Certainly, in another embodiment, the e-liquid guide member may be a cotton core, and the heating body may be a resistance wire wrapped around the cotton core, a mesh tube-like resistor wrapped around the cotton core, or the like.

The first vaporizer 2 includes a seal member 24. The seal member 24 is configured to seal the liquid storage space 211. A liquid passage 241 is provided on the seal member 24. Contact between the liquid aerosol substrate and the e-liquid guide member 22 is implemented by causing the e-liquid guide member 22 to pass through the liquid passage 241 to contact the liquid aerosol substrate in the liquid storage space 211, or by causing the liquid aerosol substrate to pass through the liquid passage 241 to contact the e-liquid guide member 22. A negative pressure hole 242 and an air pressure plug 243 may also be arranged on the seal member 24. The negative pressure hole 242 extends through the seal member 24 and protrudes into the liquid storage space 211. The air pressure plug 243 is provided with a channel inside. The air pressure plug 243 is elastic, is located in the liquid storage space 211, and is partially sleeved on a protruding portion of the negative pressure hole 242. The channel tapers from bottom to top to present a substantially conical structure. Under normal circumstances, the gas path cannot pass through a tapered position of the air pressure plug 243. Alternatively, the air pressure plug 243 partially tapers, so that the airflow cannot pass through the tapered position under normal circumstances. With the consumption of the liquid aerosol substrate in the liquid storage space 211, the negative pressure in the liquid storage space 211 becomes increasingly large. Therefore, outside air may break through the tapered area of the air pressure plug 243 and enter the liquid storage space 211 under an action of an internal and external pressure difference, so as to balance the internal and external air pressure of the liquid storage space 211 and prevent the aerosol substrate from being transmitted by the e-liquid guide member 22. Certainly, in another embodiment, the liquid storage space may also be equipped with other forms of air pressure balancing devices.

The first vaporizer 2 includes a mounting seat 25. The mounting seat 25 is configured to fix the e-liquid guide member 22 and the heating body. The first electrode 23 may extend out of the mounting seat 25 to be exposed, and the mounting seat 25 is provided with a second air inlet 251 in communication with an air inlet of the housing (which may be a first air inlet 13 on the connection cover 11 of the housing 6). In some embodiments, a quantity of second air inlets 251 may be different from a quantity of air inlets of the housing. For example, in FIG. 5, 3 second air inlets 251 are provided. In some embodiments, each second air inlet 251 is staggered from the first air inlet 13, so that air entering from the first air inlet 13 may be simply filtered.

The first vaporizer 2 further includes a liquid absorbing member, which is configured to absorb the liquid aerosol substrate leaking from the liquid storage space 211 and an aerosol condensate generated inside the first vaporizer 2 or a mouthpiece, to prevent leakage of the liquid aerosol substrate and the aerosol condensate. In some embodiments, the liquid absorbing member 252 is located in the mounting seat 25.

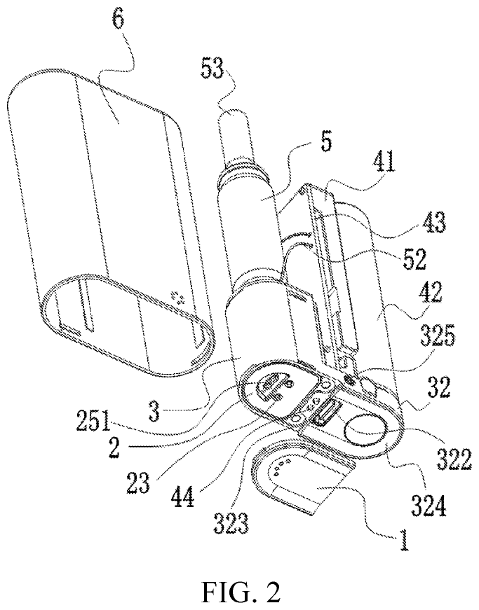

Referring to FIG. 2 to FIG. 5, the power supply assembly 4 includes a battery fixing seat 41 and a battery 42. The battery 42 is fixed in the battery fixing seat 41 and is limited and protected by the battery fixing seat 41.

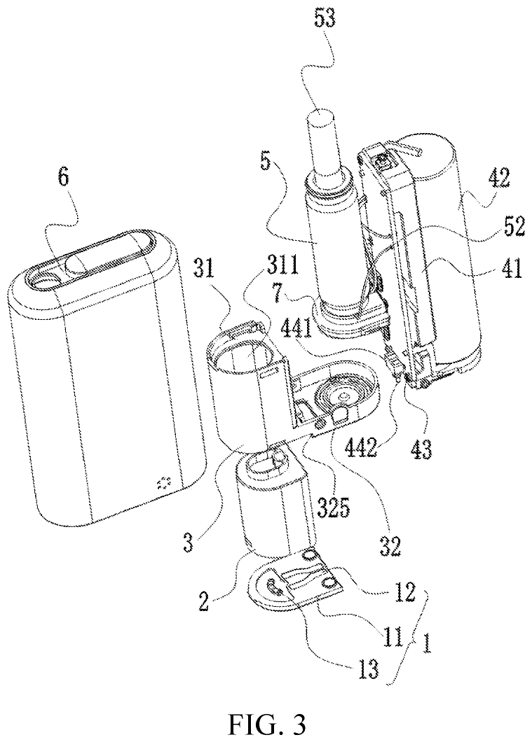

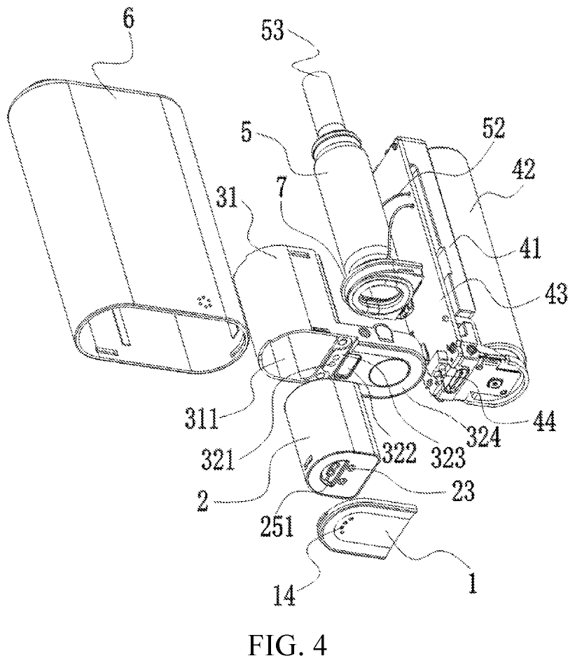

The circuit board includes a control chip and a circuit thereof, a power control and management chip and a circuit thereof, and a power supply circuit for supplying power to a plurality of components inside an electronic vaporizer device. The circuit board is connected to an electric component (such as the first vaporizer 2) by means of the power supply circuit. An output terminal of the battery 42 is electrically connected to the circuit board to externally output electric energy that meets the requirement of the electric component by means of the circuit board. Referring to FIG. 2 to FIG. 5, an output electrode has a second electrode 44 (a positive electrode and a negative electrode) therein, and the second electrode 44 is electrically connected to the connecting assembly 1. In the embodiments shown in FIG. 3 and FIG. 4, a circuit board 43 is fixed to the battery fixing seat 41 by means of a screw, a bolt, or a snap, which may be fixed at two opposite ends of the circuit board 43, such as an upper end and a lower end. As shown in FIG. 3, the second electrode 44 includes an insulating portion 441 and a conductive portion 442. One end of the conductive portion 442 is a fixed end that is fixed in the insulating portion 441 and partially exposed outside the insulating portion and electrically connected to the circuit board 43 when the insulating portion 441 is fixed to the circuit board 43. Another end of the conductive portion 442 is a connection terminal configured to be electrically connected to the connecting assembly 1. The insulating portion 441 is fixed to the circuit board 43.

Referring to FIG. 2 to FIG. 5, the circuit board 43 and the first vaporizer 2 are located on the same side of the connecting assembly 1. Specifically, a bottom end of the circuit board 43 is substantially flush with a bottom end of the first vaporizer 2, and the connecting assembly 1 is transversely arranged on a side of the bottom end of each of the first vaporizer 2 and the circuit board 43. To be specific, the first vaporizer 2 and the circuit board 43 are arranged in parallel on a side of the connecting assembly 1. In some other embodiments, when a side end of the circuit board 43 is substantially flush with a side edge of the first vaporizer 2, the connecting assembly 1 may also be arranged on the side edges of the first vaporizer 2 and the circuit board 43. In this case, the second electrode 44 of the circuit board 43 and a first electrode 23 of the first vaporizer 2 may contact the same side surface of the connecting assembly 1. Certainly, it is also feasible that the first electrode 23 and the second electrode 44 are enabled to respectively contact two sides or an end of the connecting assembly 1.

Referring to FIG. 2 to FIG. 5, the circuit board 43 is located between the battery fixing seat 41 and the first vaporizer 2. A gap exists between the circuit board 43 and the first vaporizer 2. A gap exists between at least part (for example, in a middle region) of the circuit board 43 and the battery fixing seat 41 and the battery 42. The gap contributes to heat dissipation of components on the circuit board 43. In particular, due to existence of the gap between the circuit board 43 and the shell of the first vaporizer 2, the circuit board 43 does not prevent the first vaporizer 2 from being detached from the housing 6 or loaded into the housing 6 when the first vaporizer 2 is detached from the housing 6 or loaded into the housing.

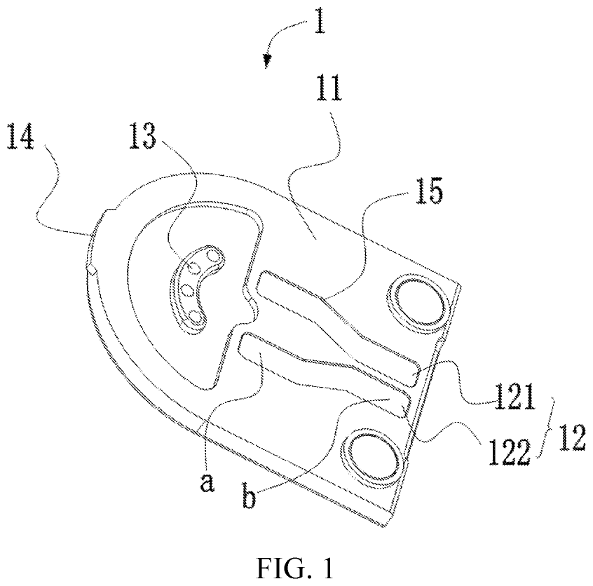

Referring to FIG. 1, the connecting assembly 1 includes a connection cover 11 and a connector 12. The connection cover 11 is insulative and may be configured to fix or accommodate the connector 12. The connector 12 is made of a conductive material (such as copper) to conduct electricity. The connector 12 is at least partially embedded in the connection cover 11, so that the connector 12 is fixed by the connection cover 11, and a side surface of the connector 12 is exposed from the connection cover 11. The first electrode 23 and the second electrode 44 are in contact with the exposed side surface of the connector 12 to realize an electrical connection. As shown in FIG. 1, the connector 12 includes a positive connector 121 and a negative connector 122 that are independent of each other. The positive connector 121 is configured to connect a high-potential point or a positive output/input terminal of each electric conductor (for example, positive terminals in the first electrode and the second electrode). The negative connector 122 is configured to connect a low-potential point or a negative output/input terminal of each electric conductor (for example, negative terminals in the first electrode and the second electrode). The positive connector 121 and the negative connector 122 may be symmetrically arranged in the connection cover 11.

The connecting assembly 1 simultaneously connects the first electrode 23 and the second electrode 44. Since the first vaporizer 2 needs to be removed for cleaning or replacement, and the first electrode 23 needs to be electrically disconnected from the second electrode 44 before the first vaporizer 2 is removed, the connector 12 is separably connected to at least one of the first electrode 23 and the second electrode 44. Specifically, as shown in FIG. 2, the connecting assembly 1 and the housing 6 are removably and movably connected or movably or slidably connected. Therefore, after the connecting assembly 1 is removed or reaches a position, the connector 12 is naturally separable from both the first electrode 23 and the second electrode 44, and the first electrode 23 is electrically disconnected from the second electrode 44. In some embodiments, the connecting assembly is fixedly connected to the first electrode (such as through welding or fixed insertion), but the connecting assembly is detachably connected to the second electrode. When the first vaporizer needs to be removed, the connecting assembly is removed together with the first vaporizer. In this case, the connecting assembly is separated from the second electrode, so that the first electrode is electrically disconnected from the second electrode. In some embodiments, the connecting assembly is fixedly connected to the second electrode, and the connecting assembly is detachably connected to the first electrode. When the first vaporizer needs to be removed, the connecting assembly is operated by moving or sliding, so that the connecting assembly is separated from the first electrode, and the first electrode is electrically disconnected from the second electrode.

Referring to FIG. 1, the connector 12 may be a sheet structure having large-area side surfaces. One large-area side surface may be embedded in the connection cover 11, and an other large-area side surface is at least partially exposed, so as to form a relatively large connection area, so as to contact the first electrode 23 or the second electrode 44 more desirably to realize the electrical connection. Since a problem of an assembly tolerance may exist in the devices in the aerosol generator, or the same material for the connecting assembly is selected due to a size deviation of different models, or the assembly is not in place when the user mounts the first vaporizer, the first electrode 23 or the second electrode 44 may contact the connector 12 in different positions (for example, a point a and a point b in FIG. 1), and the connector 12 has the large-area side surfaces to satisfy requirements for the different contact positions of the first electrode 23 or the second electrode 44. The sheet structure may be a linear sheet structure, a broken-line sheet structure (as shown in FIG. 1), or a bent sheet structure. A specific sheet structure may be adjusted based on a shape of the connection cover and another element on the connection cover, or may be accordingly designed based on a possible contact position of the first electrode or the second electrode.

The connecting assembly further includes a protruding edge. The protruding edge is arranged around the contact points between the connector 12 and the first electrode 23 and/or the second electrode 44 (for example, the point a and the point b in FIG. 1), especially on a periphery of a separable connection between the first electrode 23 or the second electrode 44 and the connector 12, which can prevent poor electrical conductivity caused by displacement as a result of poor assembly or shaking. In an embodiment, referring to FIG. 1, the connection cover 11 is provided with a groove 15. In this case, a groove wall of the groove 15 forms a completely closed protruding edge, and the connector 12 is embedded in the groove 15 and is fixed to the connection cover 11. Through arrangement, a joint of the connector 12 and the first electrode 23 or the second electrode 44 (such as the point a and the point b in FIG. 1) is located in an opening of the groove 15. Certainly, it is also feasible to provide an open protruding edge around the contact positions for the separable connection.

In some embodiments, the first electrode 23 or the second electrode 44 separably connected to the connector 12 may be a spring metal thimble, and at least part of the connector 12 may be a hard plane, or a hard concave surface, or a hard convex surface, or a hard concave-convex surface, to implement elastic abutment of the first electrode 23 or the second electrode 44 and realize desirable electrical conductivity. In some embodiments, the connecting assembly may include an elastic body (such as a spring, an elastic piece, an elastic rubber, and a sponge), which is fixed to the connector. Alternatively, the connector is made of an elastic material (for example, a metal sheet with an elastic deformation space arranged on the connection cover), and the first electrode 23 or the second electrode 44 is a metal thimble without elasticity, to implement elastic abutment of the first electrode 23 or the second electrode 44 and realize desirable electrical conductivity. Other manners that can achieve desirable contact between the connector and the first electrode or the second electrode may be used in this application.

Referring to FIG. 1, at least one first air inlet 13 extends through the connection cover 11. 4 first air inlets 13 are provided and arranged on the connection cover 11 in the shape of an arc. The first air inlets 13 may have the same aperture and may have the same hole depth. The first air inlets 13 and the connector 12 are staggered. In some embodiments, the first air inlets may alternatively be provided on the housing.

Referring to FIG. 1, the connection cover 11 covers an assembly opening 311 provided on the housing 6, and the first vaporizer 2 enters the housing 6 through the assembly opening 311 or may be removed from the housing 6 through the assembly opening 311. In some embodiments, the assembly opening 311 on the housing 6 is in an opposite direction of an air outlet of the first vaporizer 2, an air outlet of the aerosol generator usually faces upward to facilitate inhalation for the user, and the assembly opening 311 is provided in the opposite direction of the air outlet, so as to prevent the assembly opening 311 from being easily observed by the user. In this case, the housing 6 is used as a reference object. The assembly opening 311 and the air outlet are oppositely arranged at two ends of the housing 6. In this case, the assembly opening 311 is used as a reference object. The first vaporizer 2 is detachably mounted to the housing 6 and passes through the assembly opening 311 in an axial direction of the assembly opening 311 to enter or leave the housing 6. When the first vaporizer 2 is arranged inside the housing 6, the first electrode 23 of the first vaporizer 2 extends in the axial direction of the assembly opening 311, and the connector 12 is arranged in a radial direction of the assembly opening 311. In this case, the connector 12 abuts against the first electrode 23. However, the second electrode 44 on the circuit board 43 may also be connected to the connector 12 through fixed connection such as welding, or the separable connection same as the first electrode 23, or rotatable connection. In this embodiment, the circuit board 43 is arranged on a side edge of the first vaporizer 2, and the second electrode 44 also extends in the axial direction of the assembly opening 311 and also abuts against the first electrode 23, so as to maintain desirable electrical conductivity among the connector, the first electrode, and the second electrode and simplify the internal structure.

Referring to FIG. 1, the connecting assembly 1 is in the shape of a sheet. In this case, it may be understood that the connection cover 11 and a connecting sheet 12 are arranged in parallel. Specifically, the connection cover and the connecting sheet are both transversely arranged in the radial direction of the assembly opening. In some embodiments, the connecting assembly 1 may be special-shaped. For example, the connection cover may be a cylindrical assembly cover with a cover edge, and the connecting sheet is in the shape of a sheet. Referring to FIG. 1, a retaining structure 14 is arranged on the connection cover 11. The retaining structure 14 may be a protrusion or a recess, so that the retaining structure may be fixed to the housing 6 or a supporting structure on a fixing seat 3 by means of a snap, to maintain desirable contact between the connector 12 and the first electrode 23 or the second electrode 44. In some embodiments, the retaining structure may be a magnetic member that is fixed to a magnetic induction member on the corresponding housing or fixing seat through magnetic attraction. In some embodiments, the retaining structure may be threaded and fixed through threaded connection.

In some embodiments, a connector included in the connecting assembly is elongated. To be specific, the connector has two ends with a certain distance therebetween. One end of the connector is connected to the first electrode of the first vaporizer are connected, the other end thereof and the second electrode on the circuit board, and at least one end is separably connected, so as to realize indirect electric conduction between the first vaporizer and the circuit board. The elongated connector may be used in the foregoing at least one embodiment, for example, in the aerosol generator in which the first vaporizer and the circuit board are arranged on the same side of the connecting assembly, or may certainly be used in the aerosol generator in which the first vaporizer and the circuit board are arranged on two sides of the connecting assembly, and may be used as long as positions of the first vaporizer and the circuit board are staggered with respect to each other.

In some embodiments, a position or an angle of the connector may change relative to the connection cover, and the connecting assembly also has a push-pull member. The connector may be pushed or pulled from a first position to a second position or may be pulled or pushed from the second position to the first position through the push-pull member. When the connector is pushed or pulled to the first position, the connector comes into contact with the first electrode and the second electrode, so that the first electrode is electrically connected to the second electrode by means of the connector. When the connector is pushed or pulled to the second position, the connector is out of contact with at least one of the first electrode and the second electrode, so that the first electrode is electrically disconnected from the second electrode.

In some other embodiments, a push-pull member is arranged on the connection cover included in the connecting assembly. The connection cover is pushed or pulled by means of the push-pull member, so that the connection cover may be moved or rotated relative to the housing while being connected to the housing, the connection cover may be moved or rotated from the first position to the second position, and the connector is fixed to the connection cover. When the connection cover is pushed or pulled to the first position, the connector comes into contact with the first electrode and the second electrode, so that the first electrode is electrically connected to the second electrode by means of the connector. When the connection cover is pushed or pulled to the second position, the connector is out of contact with at least one of the first electrode and the second electrode, so that the first electrode is electrically disconnected from the second electrode.

Since the connection cover is configured to cover or expose the assembly opening provided on the housing, further, the connection cover may be pushed or pulled to the first position by pushing or pulling the connection cover, so that the connection cover covers the assembly opening, causing the connection cover to come into contact with the first vaporizer. In this way, the connection cover may provide a support force for the first vaporizer and keep the first vaporizer in the housing. Alternatively, the connection cover may be pushed or pulled to the second position by pushing or pulling the connection cover, so that the connection cover is away from the assembly opening, causing the connection cover to be out of contact with the first vaporizer. Therefore, the support force of the connection cover for the first vaporizer disappears, the assembly opening is exposed, and the first vaporizer may be separated from the housing through the assembly opening. To be specific, when the connection cover is in the first position, the connector connects the first electrode to the second electrode, so that the first electrode is electrically connected to the second electrode by means of the connector. In addition, the connection cover holds the first vaporizer in the housing by supporting the first vaporizer. However, when the connection cover is in the second position, the connector is out of contact with at least the first electrode, so that the first electrode is electrically disconnected from the second electrode. In addition, the connection cover no longer contacts the first vaporizer and the support for the first vaporizer disappears, and when the connection cover is in the second position, the assembly opening is exposed, so that the first vaporizer is separated from the housing through the assembly opening.

Referring to FIG. 2 to FIG. 4, in some embodiments, the connection cover 11 is removably connected to the housing 6. In addition, the connector 12 fixed to the connection cover 11 is separably connected to both the first electrode 23 and the second electrode 33. Therefore, when the connection cover 11 is separated from the housing 6, the connector 12 fixed to the connection cover 11 is simultaneously disconnected from the first electrode 23 and the second electrode 33, and when the connection cover 11 is separated from the housing 6, the first vaporizer 2 may be detached from the housing 6 due to loss of the support of the connecting assembly 1.

In some other embodiments, the second electrode is a flexible wire. One end of the second electrode is electrically connected to a circuit board body, and an other end is electrically connected to the connector in the connecting assembly. The wire cannot apply a sufficient abutment force to the connector, and cannot withstand an abutment force of the connector either. The connection cover is removably connected to the housing, and the connector is separably electrically connected to the first electrode. Therefore, when the connection cover is separated from the housing, the connector fixed to the connection cover is separated from the first electrode, the wire is still electrically connected to the connector, and the wire has a sufficient length. Therefore, the connection cover has enough give-way room when the connection cover is detached from the housing, so that the first vaporizer is not blocked by the connection cover when being detached from or loaded into the assembly opening. In addition, since the wire connects the body of the circuit board to the connector at all times, when the connection cover is detached from the housing, the connection cover remains connected to the circuit board, thereby preventing the connection cover from being lost.

Referring to FIG. 2 to FIG. 5 and FIG. 9, the housing 6 includes a shell and a fixing seat 3 fixed in the shell. The fixing seat 3 is configured to receive the first vaporizer 2, the power supply assembly 4, and the circuit board 43, and the first vaporizer 1 is separated from the circuit board 43, so that the first vaporizer 2 cannot directly contact the circuit board 43.

Referring to FIG. 2 to FIG. 5 and FIG. 9, the fixing seat 3 includes a main body portion 31 and an extending portion 32. The main body portion 31 may be configured to accommodate the first vaporizer 2, and the extending portion 32 may be configured to fix the power supply assembly 4 and the circuit board 43. The extending portion 32 is arranged in parallel with the main body portion 31. To be specific, the extending portion 32 is located on a side of the main body portion 31. The main body portion 31 is provided with a hollow cavity, the hollow cavity extends through the main body portion 31, and the assembly opening 311 is located on the hollow cavity of the main body portion 31. The main body portion 31 is located in a lower region inside the shell, and an opening at a lower end of the hollow cavity is adjacent to an opening at a lower end of the shell. Therefore, after the connection cover is away from the assembly opening 311 and the support for the first vaporizer 2 disappears, the first vaporizer 2 may be detached from the main body portion 31 through the opening at the lower end of the hollow cavity, and detached from the shell through the opening at the lower end of the shell, thereby realizing separation from the housing. The connection cover 11 may be connected to the shell to cover the assembly opening 311, or may be connected to the main body portion 31 to cover the assembly opening 311, and may also be simultaneously connected to the shell and the main body portion 31 to cover the assembly opening 311.

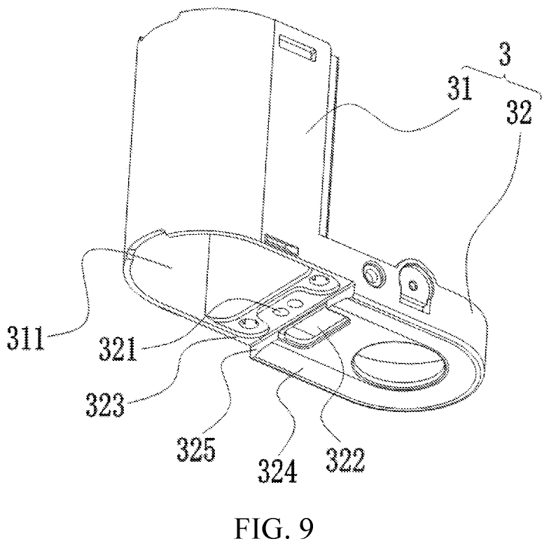

Referring to the embodiment shown in FIG. 2, the battery fixing seat 41 and the circuit board 43 are fixed to the extending portion 32 by means of screws, bolts, snaps, or the like. Vias 321 (referring to FIG. 4 and FIG. 9) extending through an upper surface and a lower surface of the extending portion 32 are provided on the extending portion. The vias 321 may be in a one-to-one correspondence with the second electrodes 44, so that connection terminals of the second electrodes 44 may pass through the vias 321 corresponding to the second electrodes to be electrically connected to the connector 12 in the connecting assembly 1. A quantity of vias 321 may be less than a quantity of second electrodes 44, so that a plurality of second electrodes 44 may pass through the same via 321 and then be electrically connected to the connector 12 in the connecting assembly 1. A charging hole 322 may also be provided on the extending portion 32. The circuit board 43 is provided with a charging circuit and a charging interface electrically connected to the charging circuit. The charging interface is at least partially located in the charging hole 322, and a charging plug is inserted into the charging hole 322 to be electrically connected to the charging interface, so as to charge the power supply assembly 4. Referring to the embodiments shown in FIG. 2 and FIG. 5, a side wall of the main body portion 31 is provided between the circuit board 43 and the first vaporizer 2. Therefore, when the connection cover 11 is pushed or pulled to the second position or separated from the housing 6, the circuit board 43 does not generate resistance to the detaching and loading of the first vaporizer 2 in a process that the first vaporizer 2 is detached from or loaded into the main body portion 31.

Further, referring to FIG. 2 and FIG. 9, a lower side of the extending portion 32 includes a first portion 323 and a second portion 324. The first portion 323 and the second portion 324 are in a stepped distribution. The first portion 323 is connected to the main body portion 31 and the second portion 324, and is substantially flush with a lower side of the main body portion 31. The second portion 324 protrudes downward relative to the first portion 323, and the first portion 323 and the second portion 324 are connected through a stepped surface 325. A part of the connecting assembly 1 covers at least part of a lower part of the main body portion 31, and an other part covers at least part of the first portion 323. The connection cover 11 in the connecting assembly 1 may abut against the stepped surface 325 between the first portion 323 and the second portion 324 in the extending portion 32. The via 321 is located in the first portion 323, so that the via may be covered by the connecting assembly 1. The charging hole 322 is located in the second portion 324, so that the charging hole may be always exposed.

Referring to FIG. 3, a first contact a and a second contact b on the connecting assembly 1 are both located on an upper surface of the connector 12. The assembly opening 311 of the fixing seat 3 is arranged downward, the housing 6 also has an opening facing downward, and a position of the assembly opening 311 is arranged corresponding to a position of the opening of the housing 6. To be specific, the first vaporizer 2 may be removed from and loaded into a lower end of the aerosol generator. The connecting assembly 1 is located below the assembly opening 311, and detaching the connecting assembly 1 or sliding/rolling the connecting assembly 1 or rotating the connecting assembly 1 may expose the assembly opening 311 or expose much of the assembly opening 311, so that when the assembly opening 311 is open enough for the first vaporizer 2 to enter and exit, the first vaporizer 2 may be detached from the assembly opening 311 under the action of its own weight or under the action of another force to facilitate removal of the first vaporizer 2. The opening of the housing 6 is arranged downward, so that a side surface of the housing 6 of the aerosol generator remains intact and has a more comfortable visual effect and aesthetic sense, which can help improve user experience and satisfy spiritual demands of the user. The first contact a and the second contact b in the connecting assembly 1 are arranged upward, so that not only the first vaporizer 2 may be disconnected from the circuit board 43 by moving the connecting assembly 1, but also restriction of the connecting assembly 1 on the first vaporizer 2 may be eliminated. The first vaporizer 2 may be detached from the assembly opening 311 in the fixing seat 3, and when the connector 12 is separably electrically connected to the first vaporizer 2, and the first vaporizer 2 is not connected to the circuit board 43, neither a connection force nor an entangling force may be generated between the circuit board 43 and the first vaporizer 2. Therefore, in a process of detaching the first vaporizer 2 from the assembly opening 311 and in a process of fitting the first vaporizer 2 into the assembly opening 311, neither the connector 12 nor the second electrode 44 interferes with the progress of the two processes, which facilitates replacement of the first vaporizer 2.

In some other embodiments, the assembly opening faces the side surface of the housing, and the first electrode is perpendicular to the circuit board and may directly abut against the second electrode on the circuit board body. An opening is also provided in a corresponding position on the side surface of the housing for replacement of the first vaporizer, and a cover may be provided to cover the opening to hold the first vaporizer in the housing.

In some other embodiments, the connecting assembly is separably electrically connected to the second electrode, so that when the connecting assembly is separated from the second electrode, the power supply assembly may be replaced.

In an embodiment of this application, the aerosol generator also includes at least one second vaporizer. The second vaporizer may be the same type of vaporizer as the first vaporizer, for example, both may be vaporizers containing a liquid aerosol substrate. The second vaporizer may also be a different type of vaporizer from the first vaporizer. For example, the first vaporizer is a vaporizer containing the liquid aerosol substrate, and the second vaporizer is a vaporizer capable of fixing and baking cigarettes and similar substances, or a vaporizer containing a solid aerosol substrate.

In some embodiments, referring to FIG. 2 to FIG. 5, the second vaporizer 5 is located above the first vaporizer 2, and is arranged side by side with the first vaporizer 2. The circuit board 43 is located on a side of the first vaporizer 2, and is arranged in parallel with the first vaporizer 2, and the second vaporizer 5 is also located on a side of the circuit board 43. The housing 6 has a third accommodating space arranged side by side with a first accommodating space, and a second accommodating space arranged in parallel with the first accommodating space therein. The first accommodating space may be configured to accommodate the first vaporizer 2, the second accommodating space may be configured to accommodate the circuit board 43, and the third accommodating space may be configured to accommodate the second vaporizer 5. A sum of volumes of the first accommodating space and the third accommodating space may be approximately equal to a volume of the second accommodating space. The connecting assembly 1 may be partially located in the first space and partially located in the second space, and the connecting assembly 1 is located below the first vaporizer 2 and the circuit board 43.

In some embodiments, referring to FIG. 5, the first vaporizer 2 is in communication with the second vaporizer 5 through a gas path. The aerosol generated by the first vaporizer 2 enters the second vaporizer 5 after leaving the first vaporizer 2, and is mixed with the aerosol in the second vaporizer 5 to form a mixed aerosol, and then the mixed aerosol flows along the gas path to a mouthpiece. The mouthpiece is configured to be held in a mouth, and inhalation through the mouthpiece may urge the aerosol to travel toward the mouthpiece along the gas path.

In some other embodiments, at least two gas paths may be provided, including a first gas path and a second gas path. The first gas path is in communication with a second air inlet on the connecting assembly, and then passes through interior of the first vaporizer. The first gas path bypasses the second vaporizer and passes into a mixing chamber close to the mouthpiece. The second gas path is in communication with the first air inlet on the connecting assembly. The second gas path bypasses the first vaporizer and passes into the second vaporizer and then into the mixing chamber adjacent to the mouthpiece. The aerosol generated by the first vaporizer and the aerosol generated by the second vaporizer are mixed in the mixing chamber and then enter the mouthpiece.

In some embodiments, no independent heating element exists in the second vaporizer, and the first vaporizer is in communication with the second vaporizer through the gas path. After a high-temperature aerosol generated by the first vaporizer enters the second vaporizer, the high temperature may cause the aerosol substrate in the second vaporizer to generate a volatile, and then the volatile is mixed with the aerosol generated by the first vaporizer and finally enters the mouthpiece.

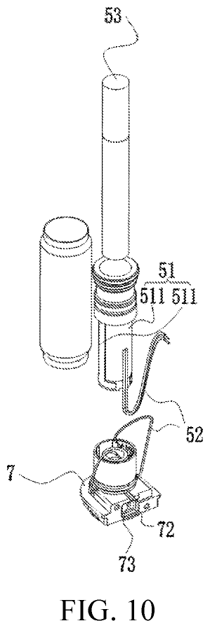

In some embodiments, referring to FIG. 5 and FIG. 10, the first vaporizer 2 is in communication with the second vaporizer 5 through the gas path. To prevent the aerosol generated by the first vaporizer 1 from condensing in the second vaporizer 5 due to temperature drop and the like when traveling along the gas path, a heating element 51 is arranged in the second vaporizer 5. The aerosol generated by the first vaporizer 2 is reheated by means of the heating element 51, and/or the aerosol substrate in the second vaporizer 5 is heated by means of the heating element 51 to volatilize. Referring to FIG. 10, the heating element 51 is arranged in the second vaporizer 5. The aerosol substrate in the second vaporizer 51 may be a solid aerosol substrate (such as a tobacco and a cigarette). The heating element 51 is electrically connected to the circuit board 43 by means of an electric conductor to obtain power from the circuit board 43. The electric conductor includes an electric conductor that supplies power to the heating element 51 to enable the heating element 51 to generate heat, and may further include an electric conductor that connects a temperature sensor in the heating element 51 to the circuit board 43 to transmit a collected temperature signal.

In some embodiments, referring to FIG. 10, an output electrode of the circuit board 43 is connected to the heating element 51 of the second vaporizer 5, so that the electric conductor that causes the heating element 51 to generate heat is a wire 52. The electric conductor connecting the output electrode of the circuit board 43 to the temperature sensor of the second vaporizer 5 is also the wire 52.

Optionally, referring to FIG. 2 to FIG. 5, the circuit board 43 has substantially the same height as the battery fixing seat 41. Therefore, part of the circuit board 43 is located on a side of the first accommodating space, and the remaining part of the circuit board 43 is located on a side of the third accommodating space. One end of the wire 52 is located in the third accommodating space, and an other end is located in the second accommodating space. The wire 52 is completely located in the third accommodating space and the second accommodating space, and the wire 52 does not pass into the first accommodating space, thereby preventing the wire 52 from passing into the first accommodating space and affecting the assembly of the fixing seat 3 and the replacement of the first vaporizer 2.

Optionally, referring to FIG. 2 to FIG. 5 and FIG. 10, the solid aerosol substrate is a cigarette 53. The mouthpiece is located on the cigarette 53, and the cigarette 53 is separably mounted in the second vaporizer 5, so that the cigarette 53 can be replaced when volatile substances in the cigarette 53 are exhausted.

In some other embodiments, a plurality of first electrodes are arranged. Part of the first electrode is connected to the first vaporizer and the connecting assembly, and is separably electrically connected to the connecting assembly. Part of the first electrode is connected to the second vaporizer and the connecting assembly, and is also separably electrically connected to the connecting assembly. To be specific, the electric conductor that connects the second electrode of the circuit board to the heating element of the second vaporizer to enable the heating element to generate heat is part of the first electrode. The first vaporizer and the second vaporizer may be connected in parallel with each other, so that the first vaporizer may be removed from the housing for replacement when the aerosol substrate in the first vaporizer is exhausted or when the first vaporizer fails, and the second vaporizer may be removed from the housing for replacement when the aerosol substrate in the second vaporizer is exhausted or the second vaporizer fails. A replacement opening for the second vaporizer may be formed at an upper end of the housing to avoid a side surface of the housing, or may be formed in a corresponding position on the side surface of the housing.

In some other embodiments, a plurality of first electrodes are arranged. Part of the first electrode is connected to the second vaporizer and the connecting assembly, and is separably electrically connected to the connecting assembly. Part of the first electrode is connected to the first vaporizer and the connecting assembly, and is inseparably electrically connected to the connecting assembly. The first vaporizer and the second vaporizer may be connected in parallel with each other, so that the second vaporizer may be removed from the housing for replacement when the aerosol substrate in the second vaporizer is exhausted or the second vaporizer fails. The replacement opening for the second vaporizer may be formed at an upper end of the housing to avoid a side surface of the housing, or may be formed in a corresponding position on the side surface of the housing.

To facilitate entry of the aerosol in the first vaporizer 2 into the second vaporizer 5, optionally, referring to FIG. 10, the heating element 51 of the second vaporizer 5 is a cylindrical heating body, which may be surrounded by at least one arc-shaped sheet 511. The arc-shaped sheet 511 surrounding the cylindrical heating body may be connected end to end, or may be spaced apart from each other end to end. The solid aerosol substrate is surrounded by the arc-shaped sheet 511, so that the heating element 51 the solid aerosol substrate in a circumferential direction, and a gap for the aerosol to pass through is provided between the solid aerosol substrates. The aerosol generated by the first vaporizer 2 enters the gap of the solid aerosol substrate of the second vaporizer 5 and directly contacts the solid aerosol substrate, and then enters the mouthpiece from an upper end of the solid aerosol substrate.

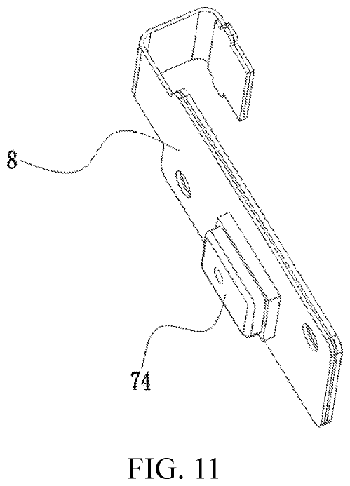

In some embodiments, referring to FIG. 5, FIG. 10, and FIG. 11, the housing 6 is also provided with a hollow connecting seat 7. The connecting seat 7 is provided with a gas chamber 71 therein. One end of the connecting seat 7 is connected to the first vaporizer 2, and the gas chamber 71 is enabled to communicate with the gas path in the first vaporizer 2. An other end of the connecting seat 7 is connected to the second vaporizer 5, and the gas path in the second vaporizer 5 is enabled to communicate with the gas chamber 71. Therefore, the gas chamber 71 forms a part of the gas path of the aerosol generator. A side edge of the connecting seat 7 is provided with a sealed cavity 72, and a through hole 73 is formed on a side wall of the sealed cavity 72. The through hole 73 communicates the sealed cavity 72 with the gas chamber 71. An airflow sensor 74 is fixed to the connecting seat 7, and the airflow sensor 74 is received and sealed by the sealed cavity 72. The through hole 73 is provided corresponding to a detection end of the airflow sensor 74. Therefore, when an inhalation action is performed at the mouthpiece, airflow in the sealed cavity 72 successively enters the gas chamber 71, the second vaporizer 5, and the mouthpiece along the through hole 73, so as to form a negative pressure in the sealed cavity 72 that can be detected by the airflow sensor 74. When the negative pressure exceeds a threshold, the airflow sensor 74 determines that the inhalation action is performed at the mouthpiece, and then a corresponding circuit on the circuit board 43 is activated, so that a corresponding element in the aerosol generator makes a response. For example, the heating elements in the first vaporizer 2 and the second vaporizer 5 generate heat, for example, a breathing light flashes, and a motor vibrates.

Further, referring to FIG. 11, the housing 6 is also provided with a connection terminal 8 therein. One end of the connection terminal 8 is connected to the connecting seat 7, and is electrically connected to the airflow sensor 74 in the connecting seat 7, and an other end is electrically connected to the circuit board 43. The airflow sensor 74 is electrically connected to the circuit board 43 by means of the connection terminal 8. The connection terminal 8 has an abutment effect, which respectively abuts against the connecting seat 7 and the circuit board 43, so that the airflow sensor 74 is inserted into the sealed cavity. The connection terminal is elastic, and the circuit board is elastically connected to the connecting seat by means of the connection terminal. The connection terminal may be retracted when the connection terminal is pushed against the circuit board, so as to prevent an event such as a break of the circuit board as a result of a deformation generated from an excessive push against the circuit board.

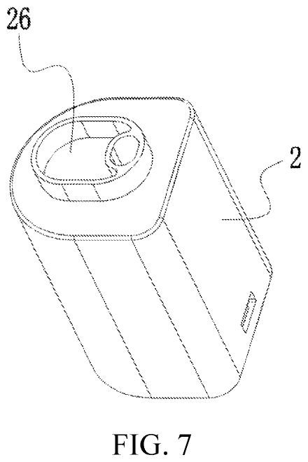

In some embodiments, referring to FIG. 5 and FIG. 7, the shell of the first vaporizer 2 is provided with a liquid storage groove 26 thereon. The liquid storage groove 26 is arranged corresponding to the gas chamber 71 and is configured to recover condensate formed in the gas chamber 71 due to temperature drop and the like.

An embodiment of this application further provides an assembly method for an aerosol generator, which may be used for assembling the foregoing aerosol generator, and includes the following steps.
S1: Move a connecting assembly 1 to expose an assembly opening 311 or expose much of the assembly opening.

A manner of moving the connecting assembly is one of the following manners: 1. The connecting assembly is removed from a housing or a fixing seat, so that the connecting assembly is separated from the housing or the fixing seat. 2. The connecting assembly is connected to the housing or the fixing seat by sliding or rolling, so that a relative position between the connecting assembly and the opening is changed by sliding or rolling the connecting assembly. 3. The connecting assembly is connected to the housing or the fixing seat by rotation, so that a relative position or a phase angle between the connecting assembly and the opening is changed by rotating the connecting assembly.
S2: Load a first vaporizer 2 into the housing 6 through the assembly opening 311.
S3: Move the connecting assembly to cover at least part of the assembly opening 311 until a connector in the connecting assembly bridges the first vaporizer and a power supply assembly.

That the connector bridges the first vaporizer and the power supply assembly means that the first vaporizer is indirectly electrically connected to the power supply assembly by using the connector as a connecting bridge.

According to the foregoing aerosol generators, since the first vaporizer and the circuit board are located on the same side with respect to the connecting assembly, the first electrode of the first vaporizer is indirectly electrically connected to the second electrode on the circuit board by means of the connector on the connecting assembly, and at least one of the first electrode and the second electrode is separable from the connector, when the first vaporizer needs to be removed, the first electrode is electrically disconnected from the second electrode, or when the first vaporizer is loaded, the first electrode may be electrically connected to the second electrode, to provide the electric energy of the power supply assembly for operation of the first vaporizer. Through this design scheme through electrical connection, the circuit board may be indirectly connected to the first vaporizer without affecting the mounting and removal of the first vaporizer.

In the foregoing aerosol generator through the connecting assembly, the first vaporizer and the circuit board in two parallel spaces may be electrically connected by means of the connecting assembly. In addition, at least the first vaporizer may be limited in the housing by means of the connecting assembly, and the first vaporizer may be enabled to not directly contact the circuit board by means of the connecting assembly. Therefore, the circuit board does not affect and interfere with the loading and removal of the first vaporizer, and does not generate damping on the first vaporizer that prevents the first vaporizer from being loaded into the housing or removed from the housing, which contributes to replacement of the first vaporizer. In addition, the connecting assembly is configured as an assembly cover. In this way, when the connecting assembly is removed or rotated or slid or rolled, the circuit board may be electrically disconnected from the first vaporizer, and at least the first vaporizer may further be exposed, thereby replacing the first vaporizer.

According to the foregoing assembly method for an aerosol generator, through movement of the connecting assembly, the housing may be opened when the first vaporizer is electrically disconnected from the circuit board, and the first vaporizer may be replaced, so that the assembly of the aerosol generator and the replacement of the first vaporizer are simpler and more interesting.

In the foregoing aerosol generator, the first vaporizer and the circuit board in parallel are electrically connected by arranging the connecting assembly, which can overcome a problem that occurs in a case of a plurality of vaporizers that the vaporizers are difficultly connected to the circuit board as a result of a limited volume and a tricky position of at least one of the vaporizers that needs replacement. In addition, the vaporizer and the circuit board are bridged by mans of the connecting assembly, so that no contact and no applied force exist between the circuit board and the vaporizer. In this way, the circuit board may not obstruct the vaporizer during replacement of the vaporizer.

It should be noted that, preferred embodiments of this application are provided in the specification and the accompanying drawings of this application, but are not limited to the embodiments described in this specification. Further, a person of ordinary skill in the art may make improvements or modifications according to the foregoing descriptions, and all of the improvements and modifications shall fall within the protection scope of the appended claims of this application.

1. An aerosol generator, comprising:
a first vaporizer, configured to vaporize a first vaporizable substrate to generate an aerosol, wherein the first vaporizer comprises a first electrode;
a power supply assembly, configured to provide electric energy required by the first vaporizer to generate the aerosol;
a circuit board, connected to the power supply assembly, wherein the circuit board comprises a second electrode for conveying the electric energy; and
a connecting assembly, comprising a conductive connector, wherein
the first vaporizer and the circuit board are located on a same side of the connecting assembly; and
the connector is configured to electrically connect the first electrode to the second electrode, and at least one of the first electrode and the second electrode is separably connected to the connector.

2. The aerosol generator according to claim 1, wherein the first electrode and the second electrode are both enabled to contact a same side surface of the connector.

3. The aerosol generator according to claim 1, wherein the first vaporizer and the circuit board are arranged in parallel, and the connecting assembly is transversely arranged on a side of a bottom end of each of the first vaporizer and the circuit board.

4. The aerosol generator according to claim 1, wherein the connector is a sheet structure.

5. The aerosol generator according to claim 1, wherein the connecting assembly further comprises a protruding edge, the protruding edge is arranged around at least part of the connector, and a separable connection between at least one of the first electrode or the second electrode and the connector is arranged in the protruding edge.

6. The aerosol generator according to claim 1, wherein the first electrode and the second electrode are spring metal thimbles, and the first electrode and the second electrode respectively elastically abut against the connector.

7. The aerosol generator according to claim 6, wherein the connecting assembly further comprises an elastic member connected to the connector, and the connector elastically abuts against the first electrode and the second electrode under an action of the elastic member.

8. The aerosol generator according to claim 1, wherein the connecting assembly further comprises a connection cover, the connector is arranged on the connection cover, the aerosol generator further comprises a housing, the housing is provided with an assembly opening for assembling of the first vaporizer, and the connection cover movably covers or exposes the assembly opening; and when the connection cover covers the assembly opening, the first electrode is electrically connected to the second electrode by means of the connector.

9. The aerosol generator according to claim 8, wherein when the connection cover exposes the assembly opening, at least one of the first electrode or the second electrode is electrically disconnected from the connector.

10. The aerosol generator according to claim 8, wherein when the connection cover covers the assembly opening, the connection cover is configured to support and hold the first vaporizer in the housing; and when the connection cover exposes the assembly opening, the first vaporizer is enabled to be removed from the housing through the assembly opening.

11. The aerosol generator according to claim 8, wherein the connecting assembly further comprises a push-pull member, the connector is arranged on the push-pull member, the push-pull member is provided with at least a first position and a second position with respect to the housing, and when the push-pull member is arranged in the first position, the connector contacts the first electrode and the second electrode; and when the push-pull member is arranged in the second position, the connector is out of contact with at least one of the first electrode and the second electrode.

12. The aerosol generator according to claim 11, wherein the push-pull member is constructed to be translatable or rotatable back and forth between the first position and the second position.

13. An aerosol generator, comprising: a housing, internally provided with a first vaporizer and a power supply assembly; and
a connection cover movably connected to the housing, wherein
the first vaporizer comprises a first electrode, and the housing is further internally provided with a second electrode electrically connected to the power supply assembly;
the housing is provided with an assembly opening, and the first vaporizer is accommodated into the housing through the assembly opening or removed from the housing through the assembly opening; and
the connection cover is configured to cover the assembly opening in a first state, keep the first vaporizer in the housing, and open the assembly opening in a second state, wherein the connection cover is able to connect the first electrode to the second electrode in the first state.

14. The aerosol generator according to claim 13, wherein the housing is further provided with a connector, the first electrode is electrically connected to the second electrode by means of the connector when the connection cover is in the first state, at least one of the first electrode and the second electrode is separated from the connector when the connection cover is in the second state, so that the first electrode is electrically disconnected from the second electrode, and the connector is arranged on a side of the connection cover facing the assembly opening.

15. An aerosol generator, comprising:
a first vaporizer, configured to generate an aerosol, wherein the first vaporizer comprises a first electrode;
a power supply assembly, configured to provide electric energy required by the first vaporizer to generate the aerosol;
a circuit board, connected to the power supply assembly, wherein the circuit board comprises a second electrode for conveying the electric energy; and
a connecting assembly, comprising a conductive connector, wherein
the connector is elongated, one end of the connector is configured to electrically connect the first electrode, an other end thereof is configured to electrically connect the second electrode, and at least one of the first electrode and the second electrode is Page 7 separably connected to the connector.

16. The aerosol generator according to claim 15, further comprising a second vaporizer, wherein the second vaporizer is configured to vaporize a second vaporizable substrate to generate an aerosol, and the second vaporizer is electrically connected to the circuit board.

17. The aerosol generator according to claim 16, further comprising a gas path, wherein the gas path communicates the first vaporizer with the second vaporizer, and the second vaporizer is located downstream of the first vaporizer in an airflow direction.

18. The aerosol generator according to claim 16, wherein the second vaporizer comprises a chamber configured to accommodate a solid vaporizable substrate and a heater configured to heat the solid vaporizable substrate to generate an aerosol.

19. (canceled)
